(19) United States
(12) Patent Application Publication
(10) Pub. No.: US 2015/0271379 A1
(43) Pub. Date: Sep. 24, 2015

(54) HEAD OF IMAGING APPARATUS, AND IMAGING APPARATUS

(71) Applicant: Kabushiki Kaisha Toshiba, Tokyo (JP)

(72) Inventors: Junya Fukumoto, Mitaka Tokyo (JP); Akihiko Kubota, Oume Tokyo (JP)

(21) Appl. No.: 14/666,092

(22) Filed: Mar. 23, 2015

(30) Foreign Application Priority Data
Mar. 19, 2014 (JP) JP2014-057229

(51) Int. Cl. H04N 5/235

(52) U.S. Cl. CPC H04N 5/2351; H04N 5/2353

(57) ABSTRACT

A head of an imaging apparatus of an embodiment includes: an imaging element having a rolling shutter function and configured to output an analog image signal in correspondence with a light amount of an object of shooting; an analog amplifier configured to amplify or attenuate a signal level of the analog image signal outputted from the imaging element in correspondence with an inputted gain to output the amplified or attenuated analog image; a converter configured to convert the amplified or attenuated analog image signal outputted from the analog amplifier into a digital signal to output the digital signal, and clip the digital signal of which the signal level exceeds a maximum output level, at the maximum output level; and a gain controller configured to control a gain inputting to the analog amplifier in a range including a minus gain.

### CROSS REFERENCE TO RELATED APPLICATION

This application is based upon and claims the benefit of priority from Japanese Patent Application No. 2014-057229, filed on Mar. 19, 2014; the entire contents of which are incorporated herein by reference.

### FIELD

Embodiments described herein relate generally to a head of an imaging apparatus which uses an image sensor having a rolling shutter function, and an imaging apparatus.

### BACKGROUND

Among imaging apparatuses such as an endoscope for medical application and a camera for a broadcast station, there is recently one that takes a picture of an object to be photographed by using a shutter function, without using an aperture or an ND filter. In such an imaging apparatus, an influence of a rolling shutter becomes prominent when a picture of an object to be photographed with a high luminance is taken, due to a higher sensitivity of an image sensor and usage of a CMOS (complementary metal oxide semiconductor). Further, because of increase of a normal sensitivity of a sensor or a camera, there appears a sensor which has a saturation electron number more than enough in relation to a normal sensitivity.

In taking a picture of an object to be photographed with a high luminance, making a shutter speed high is only way for an imaging apparatus without an aperture function to reduce a brightness. However, in such a case, due to a characteristic of a rolling shutter, fluctuation of brightness has a different influence every line, and as a result, there is a case where dark and light horizontal stripes appear in one screen, for example. Further, when a sensitivity is reduced in a digital gain after A/D conversion, a dynamic range is reduced, sometimes causing what is called a white spot of an image of a bright part.

### BRIEF DESCRIPTION OF THE DRAWINGS

FIG. 1 is a block diagram showing a configuration of an imaging apparatus of an embodiment 1.

FIG. 2 is a block diagram showing a configuration of a head of the imaging apparatus shown in FIG. 1.

FIG. 3 is a graph showing a relation between an input signal and an output signal of an A/D converter shown in FIG. 1.

FIG. 4 is a graph showing a relation between the input signal and the output signal of the A/D converter in a case where desensitizing is performed before A/D conversion and in a case where desensitizing is performed after A/D conversion.

FIG. 5 is a block diagram showing a configuration of an imaging apparatus of an embodiment 2.

FIG. 6 is a functional configuration diagram showing each function of an automatic exposure adjustment function section of an MPU shown in FIG. 5.

FIG. 7 is a graph for explaining an action of the automatic exposure adjustment function section.

### DETAILED DESCRIPTION

A head of an imaging apparatus of an embodiment includes: an imaging element having a rolling shutter function and configured to output an analog image signal in correspondence with a light amount of an object of shooting; an analog amplifier configured to amplify or attenuate a signal level of the analog image signal outputted from the imaging element in correspondence with an inputted gain to output the amplified or attenuated analog image; a converter configured to convert the amplified or attenuated analog image signal outputted from the analog amplifier into a digital signal to output the digital signal, and clip the digital signal of which the signal level exceeds a maximum output level, at the maximum output level; and a gain controller configured to control a gain inputting to the analog amplifier in a range including a minus gain.

### Embodiment 1

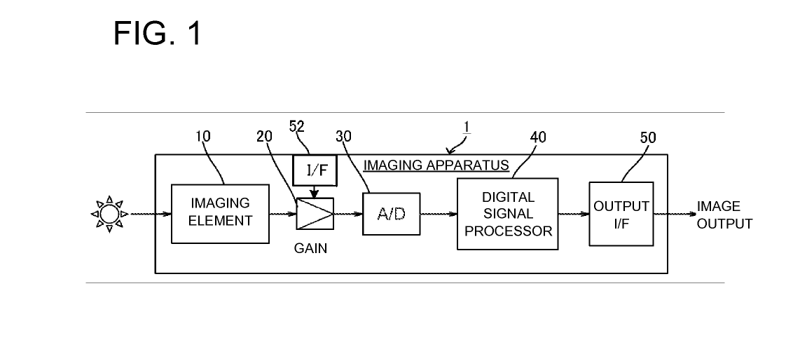

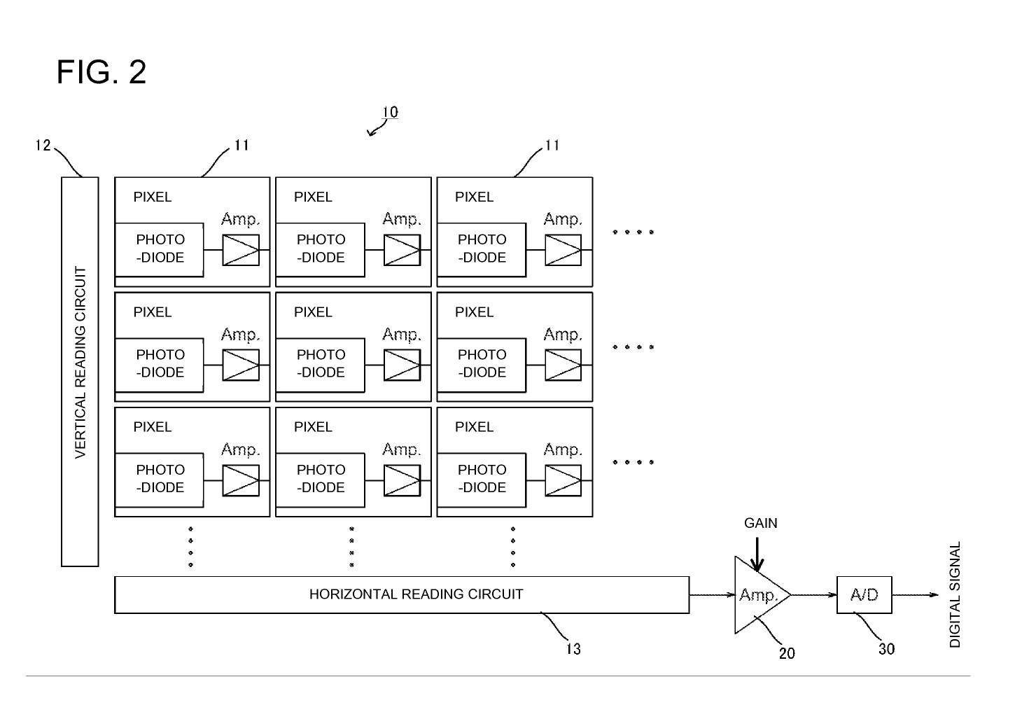

Hereinafter, an embodiment will be described with reference to the drawings. FIG. 1 is a block diagram showing a configuration of an imaging apparatus 1 of an embodiment 1. FIG. 2 is a block diagram showing a configuration of a head of the imaging apparatus 1 shown in FIG. 1.

As shown in FIG. 1, the imaging apparatus 1 has an imaging element 10, an analog amplifier 20, an analog/digital converter (hereinafter, referred to as an “A/D converter”) 30, a digital signal processing unit 40, an output interface (hereinafter, referred to as an “output I/F”) 50, and a user interface (hereinafter, referred to as a “user I/F”) 52. Note that the imaging element 10, the analog amplifier 20, the A/D converter 30 constitute a head of the imaging apparatus 1. The digital signal processing unit 40, the output I/F 50, and the user I/F 52 constitute a control unit of the imaging apparatus 1.

As shown in FIG. 2, the imaging element 10 is constituted with a CMOS image sensor having a rolling shutter function. The CMOS image sensor 10 has a photodiode (light receiving part) and an amplifier (Amp) per pixel 11. The photodiode in each pixel 11 receives light from an object for shooting, converts the light into the number of electrons in correspondence with a light amount thereof by a photoelectric conversion function, and then stores the electrons. The electrons stored in the photodiode are converted into a voltage and amplified by the amplifier in the pixel 11 where the photodiode is.

The amplified voltage is selected and read every line by pixel selection by a vertical reading circuit 12 and temporarily stored after a noise is removed. The stored voltage is selected every column and read as a voltage signal (analog signal) by a horizontal reading circuit 13.

The CMOS image sensor 10 has a maximum electron number (saturation electron number) to be able to be accumulated per unit pixel, and there are outputted the maximum electron number or fewer of analog signals of a signal level in correspondence with a light amount of the object of shooting.

The analog amplifier 20 increases (sensitizes) or attenuates (desensitizes) the signal level of the analog signal inputted from the horizontal reading circuit 13 of the CMOS image sensor 10. In other words, to the analogy amplifier 20, a gain instruction from a user is inputted via the user I/F 52. The analog amplifier 20 amplifies or attenuates the signal level of the analog signal inputted from the CMOS image sensor 10 in correspondence with the inputted gain.

Note that with regard to the user I/F 52 a user can set a gain of the analog amplifier 20 arbitrarily and that the gain set by the user is outputted to the analog amplifier 20 as the gain instruction.

Further, a sensitizing function of the imaging apparatus 1 which increases the signal level is actualized as a result of setting of an analog gain in the analog amplifier 20 or setting of a digital gain in the digital signal processing unit 40.

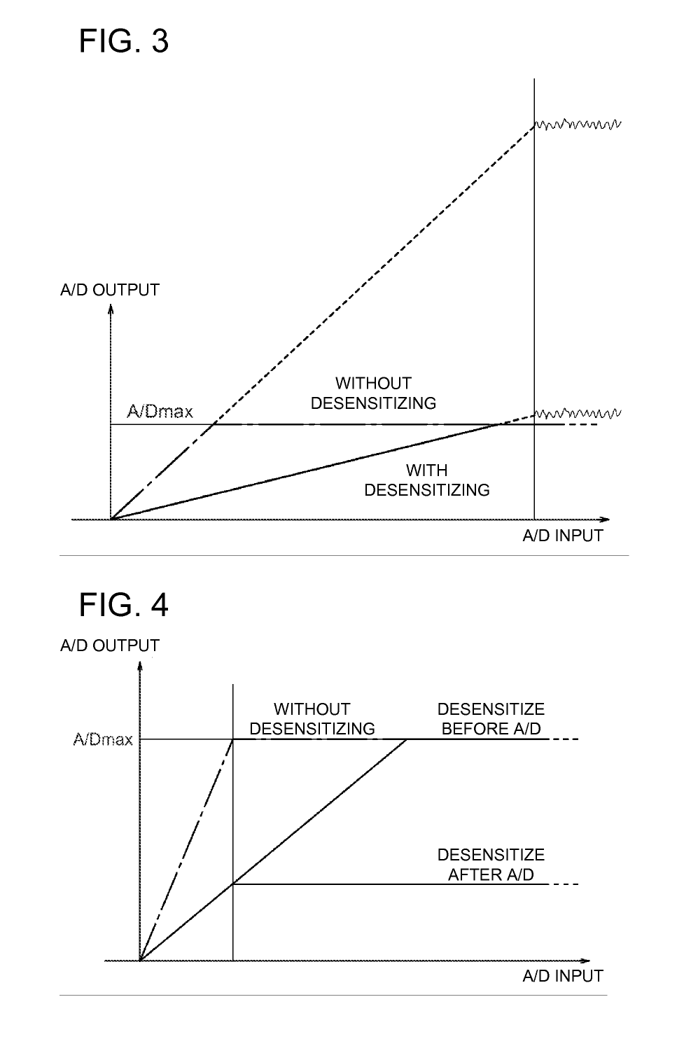

FIG. 3 is a graph showing a relation between an input signal and an output signal of the A/D converter 30 shown in FIG. 1.

The A/D converter 30 converts an analog signal inputted from the analog amplifier 20 into a digital signal. As shown in FIG. 3, in the A/D converter 30, there is set a maximum output level of a converted digital signal in response to an inputted analog signal, that is, an A/Dmax of an A/D output.

Here, a saturation electron number of the CMOS sensor 10 is larger than a saturation electron number at a time that the A/D output of the A/D converter 30 becomes the A/Dmax, in a state where a gain of the analog amplifier 20 is of a standard setting, for example, in a state of without desensitizing (when the gain is 0 [dB]) in FIG. 3. Thus, in the A/D converter 30, the A/D output is clipped to the A/Dmax before the photodiodes in the CMOS image sensor 10 is saturated.

The saturation electron number varies depending on the pixel, and when a saturated image is outputted from the imaging apparatus 1, that image becomes an image (image including a noise) of a granular image with different brightnesses.

Thus, the present embodiment adopts the CMOS image sensor 10 having a saturation electron number which causes clipping of an A/D output outputted from the A/D converter 30 before the saturation of photodiodes in the CMOS image sensor 10 even when a gain of the analog amplifier 20 is set at a minus gain (for example, −15 [dB]). In other words, the present embodiment adopts the CMOS image sensor 10 having a saturation electron number which causes clipping of an A/D output from the A/D converter 30 before the number of electrons generated in respective photodiode in the CMOS image sensor 10 reaches the saturation electron number even when a gain of the analog amplifier 20 is set at a minus gain (for example, −15 [dB]).

As a result that the CMOS image sensor 10 and the A/D converter 30 are configured as above, in the analog amplifier 20, the signal level of the A/D output outputted from the A/D converter 30 can be the A/Dmax when the CMOS image sensor 10 receives the light which amount is greater than the light amount generating the saturation electron number of electrons even if a signal level of an analog signal in a state of the standard setting is attenuated in correspondence with a gain instruction (for example, −15 [dB]) inputted from the user I/F 52, for example.

As shown in FIG. 1, the digital signal processing unit (image processor) 40 image processes an image of a shooting object of the digital signal from the A/D converter 30.

The output I/F 50 outputs the image processed image to a not-shown external display device or the like, for example.

Note that adjustment of a sensitivity (sensitizing function) in the imaging apparatus 1 can be performed by setting of an analog gain of the analog amplifier 20 or setting of a digital gain of a digital amplifier 41 described later in the digital signal processing unit 40.

FIG. 4 is a graph showing a relation between an input signal (analog signal) and an output signal (digital signal) of the A/D converter 30 in a case where the analog signal is desensitized before A/D conversion and in a case where the digital signal is desensitized after A/D conversion.

As shown in FIG. 4, when the signal is desensitized by the digital signal processing unit 40 after A/D conversion in the A/D converter 30, in other words, when gain at the digital signal processing unit 40 is set at a minus value to attenuate the signal, the signal level of the digital signal outputted from the digital signal processing unit 40 cannot reach the A/Dmax and is below the A/Dmax. Consequently, an image outputted from the output I/F 50 becomes an outlined one without an image of a bright part.

In contrast, in the present embodiment, since the signal is desensitized before A/D conversion at the A/D converter 30, that is, a gain of an analog signal is set at a minus value and attenuation is performed, a digital signal outputted from the A/D converter 30 can reach the A/Dmax. Consequently, an image outputted from the output I/F becomes one including an image of a bright part without a white spot, and a sensitivity of photographing can be reduced by broadening a dynamic range. When the signal is not desensitized, the relation between the input signal (the analog signal) and the output signal (digital signal) of the A/D converter 30 varies as shown in FIG. 4.

As described above, in the present embodiment, since the image sensor with the many saturation electron number is used and the gain of the analog amplifier is controlled so that the analog gain outputted from the image sensor is attenuated at a time before A/D conversion, it is possible to reduce an adverse effect of a rolling shutter and to reduce a noise.

### Embodiment 2

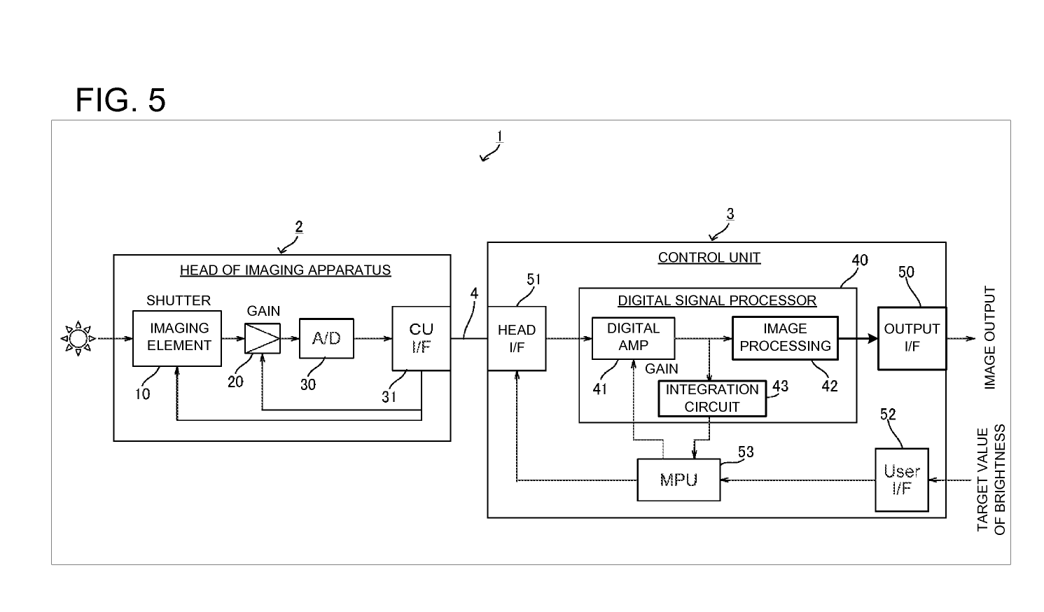

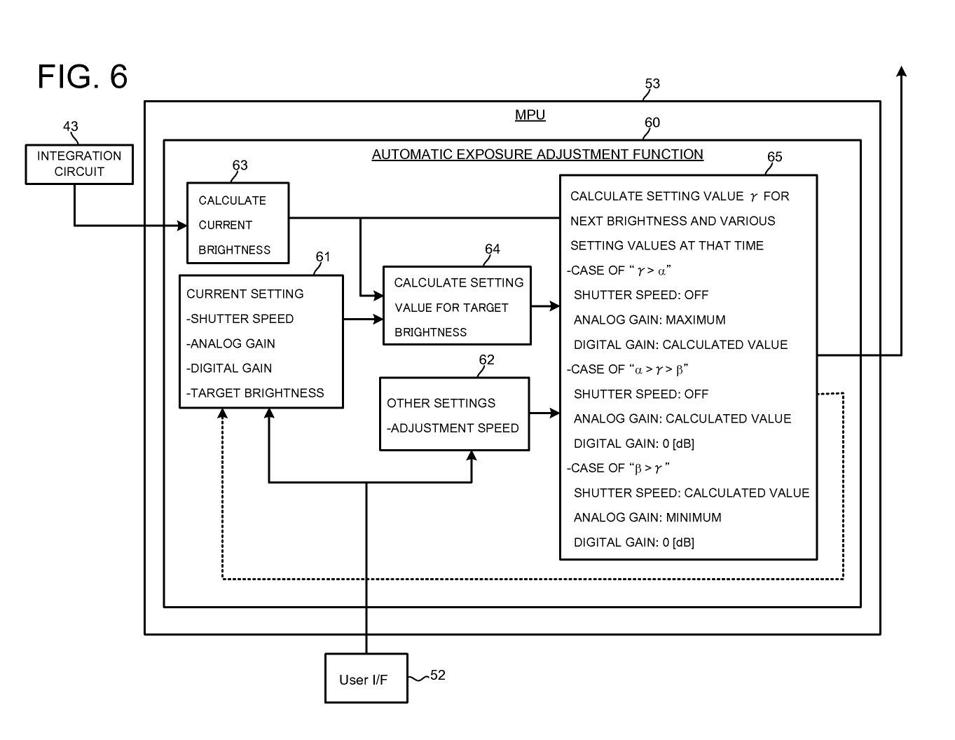

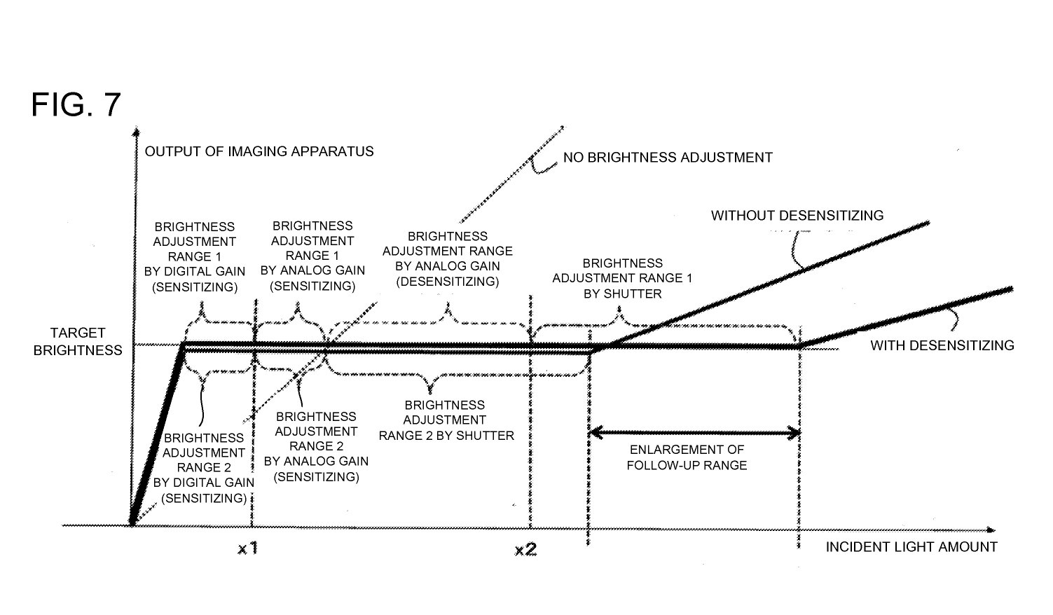

FIG. 5 is a block diagram showing a configuration of an imaging apparatus 1 of an embodiment 2. FIG. 6 is a functional configuration diagram showing each function of an automatic exposure adjustment function section 60 and is for explaining an automatic exposure adjustment function achieved by an MPU (Micro Processor Unit) 53 shown in FIG. 5 executing program stored in a memory (not shown). FIG. 7 is a graph for explaining an action of the automatic exposure adjustment function section 60.

In the present embodiment, the automatic exposure adjustment function section 60 automatically controls a brightness of an image by setting the gain of the analog amplifier 20 based on a setting value of a target brightness of an image.

The automatic exposure adjustment function section 60 controls a brightness of an image additionally by setting the gain of the digital amplifier 41 and shutter speed of the CMOS image sensor 10 having a rolling shutter function, as shown later, based on a setting value of a target brightness of an image.

The automatic exposure adjustment function section 60 sets a plurality of brightness values between the setting value of a target brightness of an image and a current brightness of the image as middle target values. The detail of the middle target values will be described later.

The automatic exposure adjustment function section 60 controls step by step a brightness of an image by setting the gain of the analog amplifier 20, the gain of the digital amplifier 41, and a shutter speed of the CMOS image sensor 10 so that the current brightness of the image successively becomes the middle target values and finally becomes the target brightness of the image.

As shown in FIG. 5, a head 2 and a control unit 3 of the imaging apparatus 1 is connected by a digital signal line 4.

The head 2 of the imaging apparatus 1 has, in addition to configuration parts shown in FIG. 1, a control unit interface (hereinafter, referred to as an “CU I/F”) 31 for outputting a digital signal A/D converted in an A/D converter 30 to the control unit 3 and taking in a gain instruction from the control unit 3, via the digital signal line 4.

The control unit 3 has, in addition to the configuration parts shown in FIG. 1, a head interface (hereinafter, referred to as an “head I/F”) 51 and the MPU 53.

Further, a digital signal processing unit 40 has the digital amplifier (digital Amp) 41, an image processing circuit 42, and an integration circuit 43.

The head I/F 51 takes in the digital signal from the head 2 and outputs a gain instruction and a shutter speed instruction from the MPU 53 to the head 2, via the digital signal line 4.

A user can arbitrarily set a target brightness of an image through the user I/F 52. The data of the target brightness inputted through the user I/F 52 is outputted to the MPU 53.

Further, the user sometimes wants to change a speed of adjusting a brightness of an image. Thus, the user may set a setting value of an adjustment speed of the target brightness with the user I/F 52, and the data of this setting value is outputted to the MPU 53.

The digital amplifier 41 amplifies or attenuates a signal level of a digital signal inputted from the head I/F 51. In other words, to the digital amplifier 41, a gain instruction from the MPU 53 is inputted. The digital amplifier 41 amplifies or attenuates the signal level of the digital signal inputted from the head I/F 51 in correspondence with the inputted gain instruction.

The integration circuit 43 integrates the signal levels of digital signals outputted from the digital amplifier 41 to calculate integration data. The integration circuit 43 outputs the integration data to the MPU 53. The integration data is used for calculation of the current brightness of the image by a first calculation function unit 63, shown later.

The integration circuit 43 integrates the signal levels of digital signals in each divisional area into which one screen area is divided by 16, for example. The integration circuit 43 outputs 16 pieces of the integration data to the MPU 53. The integration circuit 43 needs not always to integrate the signal levels of all digital signals in each divisional area. The integration circuit 43 may thin out and sample digital signals in each divisional area to integrate signal levels of the sampled digital signals.

As shown in FIG. 6, the MPU 53 has the automatic exposure adjustment function section 60. The automatic exposure adjustment function section 60 has first and second storage function portions 61, 62 and first to third calculation function portions 63 to 65.

The first storage function portion 61 stores current setting value data.

The current setting value data means respective pieces of data of a current shutter speed (exposure time of a photodiode) to be adjusted, a current gain of the analog amplifier 20, a current gain of the digital amplifier 41, and a target brightness of the image.

Among those pieces of current setting value data, the respective pieces of data of the current shutter speed, the current gain of the analog amplifier 20, and the current gain of the digital amplifier 41 are inputted from the third calculation function portion 65 and stored in the first storage function portion 61.

Further, the data of the target brightness of the image is inputted from the user I/F 52 by a setting of a user and stored in the first storage function portion 61.

The second storage function portion 62 stores setting value data of an adjustment speed for adjusting the brightness of the image. The setting value data of the adjustment speed for adjusting the brightness of the image is inputted through the user I/F 52 and stored in the second storage function portion 62.

The first calculation function portion 63 calculates a current brightness of an image from the integrated data inputted from the integration circuit 43.

In the case of calculating the current brightness of the image from the whole screen, the average value of the 16 pieces of the integration data is calculated and the average value is treated as the current brightness of the image. On the other hand, in the case of calculating the current brightness of the image from specifically remarked areas among the 16 divisional areas, the average value of the specifically remarked areas is calculated and the average value is treated as the current brightness of the image.

The second calculation function portion 64 computes a setting value for making the image at the target brightness based on the current brightness of the image calculated by the first calculation function section 63, the target brightness stored in the first storage function portion 61, the current shutter speed stored in the first storage function portion 61, the current gain of the analog amplifier 20, and the current gain of the digital amplifier 41. The setting value for making the image at the target brightness is a value expediently obtained and unitarily represented for controlling. Specifically, the setting value for making the image at the target brightness is a value indicating the amplification factor of the imaging apparatus 1 added as a whole.

The third calculation function portion 65 calculates a setting value γ for making the image at a next brightness, based on the current brightness of the image calculated by the first calculation function section 63, the setting value for making the image at the target brightness calculated by the second calculation function section 64, and the adjustment speed for adjusting a brightness of an image stored in the second storage function portion 62. The setting value γ for making the image at the next brightness is also a value indicating the amplification factor of the imaging apparatus 1 added as a whole.

The next brightness, which would like to be achieved as a brightness of the image as a result of controlling based on the calculated setting value γ for making the image at the next brightness, corresponds to the plurality of middle target values described above.

The third calculation function portion 65 has two setting values α and β which are standards for comparing with the setting value γ for making the image at the next brightness. Here, the setting values α and β are fixed values, and have a relation of “setting value α>setting value β”. Of course, the setting values α and β are also values indicating the amplification factor of the imaging apparatus 1 added as a whole.

Hereinafter, the setting values α and β will be explained by using FIG. 7. FIG. 7 is a graph for describing the operation of the automatic exposure adjustment function section 60. The horizontal axis of the graph indicates the light amount of the light inputted in the imaging apparatus 1, or an input light amount. The longitudinal axis of the graph indicates the brightness of the image which is an output of the imaging apparatus 1.

FIG. 7 includes three types of line graphs. A first line graph is labeled as “no brightness adjustment”. A second line graph is labeled as “without desensitizing”. A third line graph is labeled as “with desensitizing”.

FIG. 7 shows the three line graphs of “no brightness adjustment”, “without desensitizing”, and “with desensitizing” in the case of the imaging apparatus 1 including the CMOS image sensor 10 having the saturation electron number which causes clipping of the A/D output outputted from the A/D converter 30 before the saturation of photodiodes of the CMOS image sensor 10 even when a gain of the analog amplifier 20 is set at a minus gain (for example, −15 [dB]).

The line graph in case of the “no brightness adjustment” shows the relationship between the input light amount and the brightness of the image when none of the gain of the analog amplifier 20, the gain of the digital amplifier 41, and the shutter speed is adjusted (“no brightness adjustment”). The “no brightness adjustment” means that both of the gain of the analog amplifier 20 and the gain of the digital amplifier 41 are set at 0 [dB] and the shutter speed is set at off-state.

The line graph in case of the “without desensitizing” shows the relationship between the input light amount and the brightness of the image when the gain of the analog amplifier 20 is adjusted between minimum (for example, 0 [dB]) and maximum (for example, 20 [dB]), in other words, the gain of the analog amplifier 20 is not set at a minus value, and the signal is not attenuated (“without desensitizing”). The line graph in case of the “without desensitizing” shows the relationship between the input light amount and the brightness of the image of conventional art. In the case of “without desensitizing”, the gain of the digital amplifier 41 are adjusted between 0 [dB] and 20 [dB], for example, and the shutter speed is adjusted between off-state and 0.1 [m sec].

The line graph in case of the “with desensitizing” shows the relationship between the input light amount and the brightness of the image when the gain of the analog amplifier 20 is adjusted between minimum (for example, −15 [dB]) and maximum (for example, +20 [dB]), in other words, the signal is desensitized by setting the gain of the analog amplifier 20 at a minus value to attenuate the signal. The line graph in case of the “with desensitizing” shows the relationship between the input light amount and the brightness of the image of the second embodiment. In the case of “with desensitizing”, the gain of the digital amplifier 41 are adjusted between 0 [dB] and 20 [dB], for example, and the shutter speed is adjusted between off-state and 0.1 [m sec].

The setting values α indicates the amplification factor of the imaging apparatus 1 added as a whole in the case that the gain of the digital amplifier 41 is set at 0 [dB], the shutter speed is set at off-state, the gain of the analog amplifier 20 is set at maximum, for example, 20 [dB]. If the amplification factor of the imaging apparatus 1 added as a whole is assumed to be α in the case that the input light amount is x1 in FIG. 7, the brightness of the image becomes equal to the target brightness. In other words, in the case that the input light amount is x1, the setting value calculated by the second calculation function portion 64 for making the image at the target brightness is α.

Similarly, the setting values β indicates the amplification factor of the imaging apparatus 1 added as a whole in the case that the gain of the digital amplifier 41 is set at 0 [dB], the shutter speed is set at the off-state, the gain of the analog amplifier 20 is set at minimum, for example, −15 [dB]. If the amplification factor of the imaging apparatus 1 as a whole is assumed to be β in the case that the input light amount is x2 in FIG. 7, the brightness of the image becomes equal to the target brightness. In other words, in the case that the input light amount is x2, the setting value calculated by the second calculation function portion 64 for making the image at the target brightness is β.

The input light amounts x1 and x2 have the magnitude relationship “the input light amount x1<the input light amount x2”. Therefore, if light of the input light amounts x1 and x2 are inputted in the imaging apparatus 1, the amplification factors of the imaging apparatus 1 as a whole need to be respectively the setting values α and β for setting the brightness of the image which is output of the imaging apparatus 1 to be the target brightness. Thus, the magnitude relationship is “the setting value α>the setting value β”.

The third calculation function portion 65 decides the setting value of the gain of the digital amplifier 41 for outputting the digital amplifier 41, the setting value of the gain of the analog amplifier 20 for outputting the analog amplifier 20, and the setting value of the shutter speed of the CMOS image sensor 10 for outputting the CMOS image sensor 10 based on the result of comparing the setting value γ for making the image at the next brightness with two setting values α and β as references.

The third calculation function portion 65 sets the gain of the digital amplifier 41 by outputting the setting value of the gain of the digital amplifier 41 to the digital amplifier 41. The third calculation function portion 65 sets the gain of the analog amplifier 20 by outputting the setting value of the gain of the analog amplifier 20 to the analog amplifier 20 via the head I/F 51 and the CU I/F 31. The third calculation function portion 65 sets the shutter speed of the CMOS image sensor 10 by outputting the setting value of the shutter speed of the CMOS image sensor 10 to the CMOS image sensor 10 via the head I/F 51 and the CU I/F 31.

The brightness of the image is controlled to be the next brightness by setting the gain of the digital amplifier 41, the gain of the analog amplifier 20, and the shutter speed of the CMOS image sensor 10.

After the brightness of the image varies as a result of the control, similarly as shown above, the third calculation function portion 65 calculates a setting value γ for making the image at the next brightness, based on the current brightness of the image, the setting value for making the image at the target brightness, and the adjustment speed for adjusting the brightness of the image. After that, the third calculation function portion 65 successively calculates a setting value γ for making the image at the next brightness, and sets the gain of the digital amplifier 41, the gain of the analog amplifier 20, and the shutter speed of the CMOS image sensor 10 so that the brightness of the image is controlled to be the target brightness.

Hereinafter, the operation by the third calculation function portion 65 for comparing the setting value γ for making the image at the next brightness with two setting values α and β.

*[in case that the setting value γ for making the image at the next brightness and the setting value α have a relationship “γ>α”]

Here, the relationship “γ>α” means small input light amount and dark image. In other words, it means the setting value as the amplification factor is calculated to be a large value for making the image at the next brightness.

The third calculation function portion 65 decides the setting value of the gain of the digital amplifier 41 for outputting the digital amplifier 41, the setting value of the gain of the analog amplifier 20 for outputting the analog amplifier 20, and the setting value of the shutter speed of the CMOS image sensor 10 for outputting the CMOS image sensor 10 based on the result of comparing the setting value γ for making the image at the next brightness with the setting values α and β.

The third calculation function portion 65 decides the shutter speed to be the off-state. The off-state of the shutter speed means no use of shutter function. Thus, if the CMOS image sensor 10 is assumed to take movies with the number of frames per second is 60, or 60 fps, the off-state of the shutter speed means that the exposure time of the CMOS image sensor 10 is set at 1/60 [sec]. The third calculation function portion 65 sets the gain of the analog amplifier 20 at maximum, for example, 20 [dB]. When the third calculation function portion 65 sets the shutter speed at the off-state, and the gain of the analog amplifier 20 at maximum, the third calculation function portion 65 calculates the setting value of the gain of the digital amplifier 41 which is need for making the amplification factor of the imaging apparatus 1 as a whole at the setting value γ.

*[in case that the setting value γ for making the image at the next brightness and setting values α and β have a relationship “α>γ>β”]

The third calculation function portion 65 decides the shutter speed to be the off-state, in other words, the exposure time of the CMOS image sensor 10 is set at 1/60 [sec]. The third calculation function portion 65 sets the setting value of the gain of the digital amplifier 41 at 0 [dB]. When the third calculation function portion 65 sets the shutter speed at the off-state, and the gain of the digital amplifier 41 at 0 [dB], the third calculation function portion 65 calculates the setting value of the gain of the analog amplifier 20 which is need for making the amplification factor of the imaging apparatus 1 as a whole at the setting value γ.

*[in case that the setting value γ for making the image at the next brightness and setting value β have a relationship “β>γ”]

Here, the relationship “β>γ” means that the input light amount is large and the brightness of the image is larger than the target brightness. In other words, it means the setting value γ as the amplification factor is calculated to be a small value for making the image at the next brightness.

The third calculation function portion 65 decides the gain of the analog amplifier 20 to be the minimum. The minimum is a minus value, for example, −15 [dB] decided by the relationship between the saturation electron number and A/D max.

When the third calculation function portion 65 sets the analog amplifier 20 at minimum, for example, −15 [dB], and the setting value of the gain of the digital amplifier 41 at 0 [dB], the third calculation function portion 65 calculates the setting value of the shutter speed which is need for making the amplification factor of the imaging apparatus 1 as a whole at the setting value γ.

In the line graph of with desensitizing” in FIG. 7, in the case of the relation “γ>α”, the brightness of the image does not reach the brightness set as the next brightness, even if the amplification factor of whole of the imaging apparatus 1 is set α. So, amplifying (sensitizing) of the digital amplifier 41 is necessary for adjusting the image signal. Thus, the third calculation function portion 65 controls to increase the amplification factor of the imaging apparatus 1 added as a whole so that the brightness of the image becomes equal to the brightness set as the next brightness. In other words, the third calculation function portion 65 controls the brightness of the image to be the brightness set as the next brightness by setting the shutter speed at the off-state, the gain of the analog amplifier 20 at the maximum, the gain of the digital amplifier 41 at the calculated value. The calculated gain of the digital amplifier 41 increases so that the brightness of the image becomes the brightness set as the next brightness. In FIG. 7, the range controlled as shown above is labeled as “brightness adjustment range 1 by digital gain (sensitization)”.

In the case of the relation “α>γ>β”, the brightness of the image is too large if the amplification factor of whole of the imaging apparatus 1 is set at α. On the other hand, the brightness of the image is too small if the amplification factor of whole of the imaging apparatus 1 is set at β. Thus, the third calculation function portion 65 controls the gain of the analog amplifier 20 between the minimum and the maximum to sensitize or desensitize the image signal so that the brightness of the image becomes equal to the brightness set as the next brightness. In other words, the third calculation function portion 65 controls the brightness of the image to be the brightness set as the next brightness by setting the shutter speed at the off-state, the gain of the digital amplifier 41 at 0 [dB], and the gain of the analog amplifier 20 at the calculated value. In FIG. 7, the ranges controlled as shown above are labeled as “brightness adjustment range 1 by analog gain (sensitization)” and “brightness adjustment range by analog gain (desensitization)”.

In the case of the relation “β>γ”, the brightness of the image is too large if the amplification factor of whole of the imaging apparatus 1 is set at β. So, adjusting of the image signal is needed by attenuating (desensitizing) the amplification factor to become below β. Thus, the third calculation function portion 65 sets the amplification factor of the imaging apparatus 1 added as a whole below β so that the brightness of the image becomes equal to the brightness set as the next brightness. In other words, the third calculation function portion 65 controls the brightness of the image to be the brightness set as the next brightness by setting the gain of the analog amplifier 20 at the minimum, and the gain of the digital amplifier 41 at 0 [dB], and the shutter speed at the calculated value. In the case of the relation “β>γ”, further adjusting of brightness by controlling the gain of the analog amplifier 20 is impossible, thus the shutter which is not used the cases shown above is used, and brightness is adjusted by controlling the shutter speed to attenuate (desensitize) the image signal. In FIG. 7, the range controlled as shown above is labeled as “brightness adjustment range 1 by shutter”.

The merit of the embodiment will be described by referring the line graphs of “no brightness adjustment”, and “without desensitizing” in FIG. 7. As shown in the line graph of “no brightness adjustment”, in the case of “no brightness adjustment”, the brightness of the image may over the target brightness. Therefore, adjusting of the image signal is necessary.

Referring the line graph of “without desensitizing”, the line graph indicates the relationship of the input light amount and the brightness of the image of conventional art. In the case of “without desensitizing”, when the input light amount is small and the brightness of the image is below the target brightness, the brightness of the image is controlled to be the target brightness by controlling the gains of the analog amplifier 20 and the digital amplifier 41. Here, the gain of the analog amplifier 20 is adjusted between minimum, for example, 0 [dB] and maximum, for example, +20 [dB]. Note that the gain of the analog amplifier 20 is plus.

In the line graph of “without desensitizing”, the range where brightness is adjusted by controlling the gain of the digital amplifier 41 is labeled as “brightness adjustment range 2 by digital gain (sensitization)”. In the line graph of “without desensitizing”, the range where brightness is adjusted by controlling the gain of the analog amplifier 20 is labeled as “brightness adjustment range 2 by analog gain (sensitization)”.

When the input light amount increases and the brightness of the image is over the target brightness, resulting in no necessity of adjusting the gains of the analog amplifier 20 and the digital amplifier 41, the shutter function is used and the brightness of the image is controlled to be the target brightness by controlling the shutter speed. In FIG. 7, the region controlled as shown above is labeled as “brightness adjustment range 2 by shutter”. If the input light amount increases more, the brightness of the image is over the target brightness even if controlling the shutter speed.

Comparing the line graphs of “with desensitizing” and “without desensitizing” in FIG. 7, as shown in the embodiment 2, the range, where the brightness of the image is maintained at the target brightness in the case of increasing the input light amount, is enlarged. The enlarged area is labeled as “enlargement of follow-up range”.

As described above, according to the imaging apparatus 1 of the present embodiment 2, as shown in FIG. 7, a range where an input light amount can be maintained at the target brightness can be enlarged by controlling the gain of the analog amplifier to desensitize the image signal, resulting in adjusting the light amount.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. A head of an imaging apparatus comprising:
an imaging element having a rolling shutter function and configured to output an analog image signal in correspondence with a light amount of an object of shooting;
an analog amplifier configured to amplify or attenuate a signal level of the analog image signal outputted from the imaging element in correspondence with an inputted gain to output the amplified or attenuated analog image;
a converter configured to convert the amplified or attenuated analog image signal outputted from the analog amplifier into a digital signal to output the digital signal, and clip the digital signal of which the signal level exceeds a maximum output level, at the maximum output level; and
a gain controller configured to control a gain inputting to the analog amplifier in a range including a minus gain.

2. An imaging apparatus comprising:
an imaging element having a rolling shutter function and configured to output an analog image signal in correspondence with a light amount of an object of shooting;
an analog amplifier configured to amplify or attenuate a signal level of the analog image signal outputted from the imaging element in correspondence with an inputted gain to output the amplified or attenuated analog image;
a converter configured to convert the amplified or attenuated analog image signal outputted from the analog amplifier into a digital signal to output the digital signal, and clip the digital signal of which the signal level exceeds a maximum output level, at the maximum output level;
a digital signal processing unit having a digital amplifier configured to amplify a signal level of the digital signal outputted from the converter in correspondence with an inputted setting value of a gain, the digital signal processing unit configured to output an image signal based on the digital signal amplified by the digital amplifier;
an input unit configured to input a target brightness of an image; and
a controller configured to output setting values of gains to the analog amplifier and the digital amplifier, and output a setting value of a shutter speed to the imaging element.

3. The imaging apparatus of claim 2,
wherein the controller further includes:
a brightness calculation portion configured to calculate a current brightness of an image based on the digital signal outputted from the converter;
a gain calculation portion configured to calculate setting values of gains of the analog amplifier and the digital amplifier based on the calculated current brightness of the image and the target brightness of the image; and
a shutter speed calculation portion configured to calculate a setting value of the shutter speed based on the calculated current brightness of the image and the target brightness of the image.
